(19) United States
(12) Patent Application Publication
(10) Pub. No.: US 2026/0087785 A1
(43) Pub. Date: Mar. 26, 2026

(54) SPATIALLY CONSISTENT GEOLOCATION MODEL

(71) Applicant: Tera AI, Inc., San Francisco, CA (US)

(72) Inventors: Héctor CARRIÓN, San Francisco, CA (US); Haoyu ZHANG, San Francisco, CA (US); Matthew TRANG, San Francisco, CA (US); Victor HERNANDEZ, San Francisco, CA (US); Emanuel RAMIREZ, San Francisco, CA (US); Ayush ZENITH, San Francisco, CA (US); Eric WEISS, San Francisco, CA (US)

(21) Appl. No.: 19/339,112

(22) Filed: Sep. 24, 2025

Related U.S. Application Data
(60) Provisional application No. 63/698,799, filed on Sep. 25, 2024.
(60) Provisional application No. 63/800,910, filed on May 6, 2025.

(51) Int. Cl. G06V 10/774; G06N 20/00; G06V 10/776; G06V 20/56

(52) U.S. Cl. CPC G06V 10/774; G06N 20/00; G06V 10/776; G06V 20/56; G06V 2201/10

(57) ABSTRACT

There is provided a method of determining a location of an image within a target geographic region, based on one or more characteristics of the image, comprising: determining a geolocation reference set for the target geographic region, the geolocation reference set including a plurality of reference images of the target geographic region, encoding, with a machine learning model, the one or more reference images into a spatially consistent latent space to generate a plurality of first encodings, receiving one or more images, encoding the one or more images into the latent space to generate a second encoding, and predicting the location of the one or more images by determining a first encoding of the plurality of first encodings that is within an encoding distance threshold of the second encoding. There is also provided a method of training the machine learning model to encode images into a spatially consistent latent space.

### CROSS-REFERENCE TO RELATED APPLICATIONS

This application claims the benefit of U.S. Provisional Application No. 63/698,799, filed Sep. 25, 2024, and U.S. Provisional Application No. 63/800,910, filed May 6, 2025, the contents of which are herein incorporated by reference in their entireties for all purposes.

### TECHNICAL FIELD

This invention relates generally to the geolocation field, and more specifically to a new and useful geolocation model in the geolocation field.

### BACKGROUND

While large language models (LLMs) are popular today, very little thought has been given to foundation models that can learn an internal representation (encodings, e.g., embeddings) of the physical world using pure vision. There therefore exists a need for such a model, as it could give rise to the type of intelligence we see in humans (spatial awareness, spatial inference, spatial navigation, and taking actions to do physical tasks).

### BRIEF DESCRIPTION OF THE DRAWINGS

FIG. 1 is an illustrative example of a data source integration architecture, according to embodiments of the disclosure.

FIG. 2 is an illustrative example of images from different modalities that may be used during training or during use of a machine learning model.

FIG. 3 is an illustrative example of images from a same modality that may be spatially or temporally linked, for use during training or during use of a machine learning model.

FIG. 4 is an illustrative example of a map indicating the presence or absence of reference data sets.

FIG. 5 is an illustrative example of interior images that may be used during training or during use of a machine learning model for interior navigation.

FIG. 6 is an illustrative example of a synthetically generated image corresponding to a real world location that may be used during training of a machine learning model.

FIG. 7 is an illustrative example of a top down view where two observations from different modalities are spatially aligned based on mutual information.

FIG. 8 is an illustrative real-world example based on the principles of FIG. 7.

FIG. 9 is an illustrate example of a masking function used during training of a machine learning model.

FIG. 10 is an illustrative example of a loss scaling function used during training of a machine learning model.

FIG. 11 is a visualization of an embedding space associated with a machine learning model.

FIG. 12 is a schematic representation of a variant of the method.

FIG. 13 is an illustrative example of a variant of training the geolocation

FIG. 14 is an illustrative example of a variant of geolocating a test measurement.

FIG. 15 is an illustrative example of using a hybrid approach for inference.

FIG. 16 is an illustrative example of a coarse alignment followed by a precise alignment using different encoding models.

FIG. 17 is an illustrative example of a hardware architecture that operates a machine learning model.

FIG. 18 is a flowchart of a method for training a machine learning model, according to an embodiment of the disclosure.

FIG. 19 is a flowchart of a method for locating an image using a machine learning model, according to an embodiment of the disclosure.

### SUMMARY

The present disclosure optionally addresses the above need by providing an all-new contrastive image-image model on earth observational data, leveraging a unique dataset having a unique training methodology to achieve high accuracy in identifying and aligning various earth visual features from aerial, street view, oblique and/or interior images.

The present disclosure optionally provides large scale, unified data processing based on a global database index that can import any real-world observation with a unified metadata system which allows for clean exporting of multi-source alignment of visual observations at a large scale.

In some embodiments, the present disclosure provides a unique real-world spatio-temporal foundation model formulation without human annotations. A new type of learning function is optionally utilized that uses visual correlations across space (distances between paired images across all types of images). This objective function is able to uniquely train a general-purpose spatial model.

One benefit to a model according to the present disclosure is that the model is able to accurately locate images, which can substitute GPS today in areas where GPS is either unavailable or blocked. An additional benefit is that unlike existing solutions, the present disclosure does not rely on human annotations, but instead, the model learns a spatial encoding (e.g., a spatial embedding) end-to-end. This produces a more robust but also more general-purpose model. An equivalent analogy is next-token prediction for LLMs, which only predicts the statistical distribution of text, which is what makes them such good general purpose foundation models when compared to the language models from the previous generation, which were narrow in capabilities and extremely brittle. Like next token prediction, the present way of training can be considered to be ‘next-token’ prediction but for images in space - where images close together in distance are close together in the embedding space.

The model of the present disclosure also optionally leverages a unique training objective which masks observations from identical spatial locations from impacting the contrastive learning as negative pairs (masked spatial contrastive). It also optionally incorporates real-world distance based loss smoothing, in order to organize the embeddings into a spatially consistent latent space. Finally, the model of the present disclosure may be implemented with an ability to either align or repel samples in the temporal dimension, allowing for robust training against or towards temporal changes in the same geographic location.

One goal of the model of the present disclosure is to provide a full GPS replacement. This helps both humans and machines to navigate, because we can install this software to run on device or over a server API. Additional goals of the model of the present disclosure are to provide one or more of the following: indoor positioning; outdoor positioning; underground positioning; and underwater positioning, using the same principles.

Another goal of the model of the present disclosure is to use the rich spatial embeddings (analogous to RAG for LLM embeddings) to connect to an action model (example: another transformer decoder module) that can direct an autonomous device (e.g. cars, planes, robots) to autonomously accomplish tasks.

### DETAILED DESCRIPTION OF THE INVENTION

The following description of the embodiments of the invention is not intended to limit the invention to these embodiments, but rather to enable any person skilled in the art to make and use this invention.

In some embodiments, the machine learning model is trained based on data from a first memory (e.g., a local or remote server or database). In some embodiments, the first memory maintains a global mapping of class IDs to filenames, addresses, S2 Cells and other signals, ensuring that each class is uniquely identified. As will be discussed in further detail below, data augmentation techniques such as zooming, flipping, and rotating images are applied probabilistically during training to enhance the model's robustness.

In some embodiments, the specific method of data collection and processing is able to universally index real world observations given their metadata, some signals of importance our method considers are: latitude, longitude, S2 Cell ID, address, year and image quality. In some embodiments, once a memory (e.g., a database) is built based on a plurality of images, the memory can be queried to export clean, multi-source observations of identical points in space across time. This first-of-its-kind memory therefore enables large-scale training of our novel AI systems. Furthermore, the data collection and processing method can be used to unify data from tens of thousands of ArcGIS servers, along with other publicly available data sources and even synthetically generated real-world imagery.

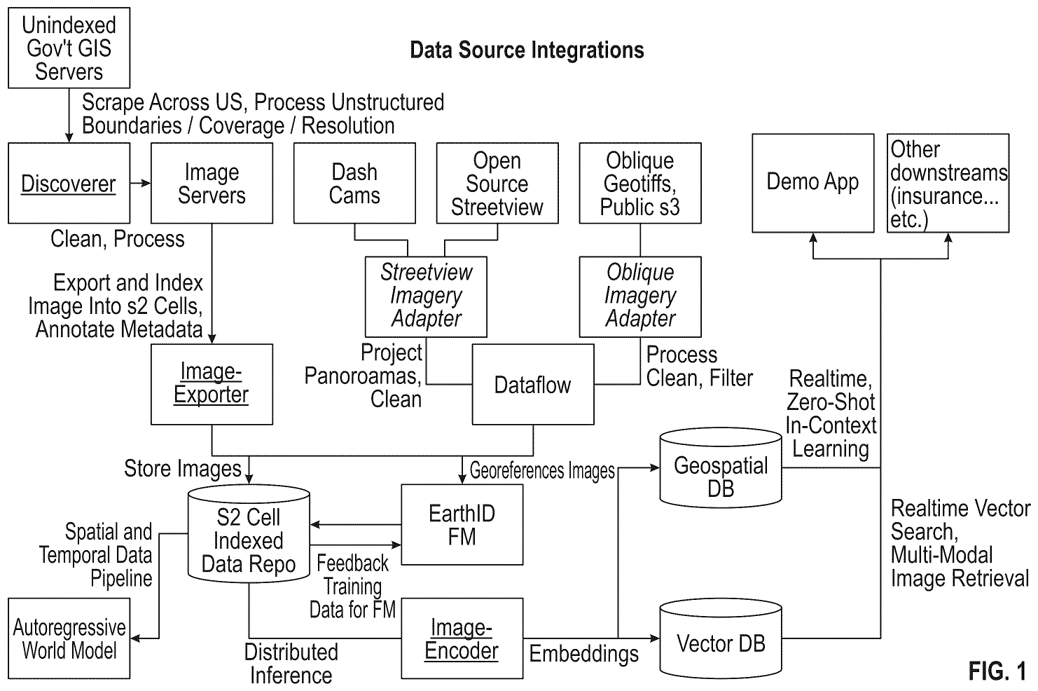

FIG. 1 illustrates an exemplary data source integration architecture. That is, the data source integration architecture provides one example of the hardware structure used to generate a training data set suitable for training a machine learning model. As shown, the data source integration relies mainly on three processing elements (“discoverer”, “image-exporter”, and “image-encoder”) that interact with servers, databases, repositories, and/or memories for generating the training data set.

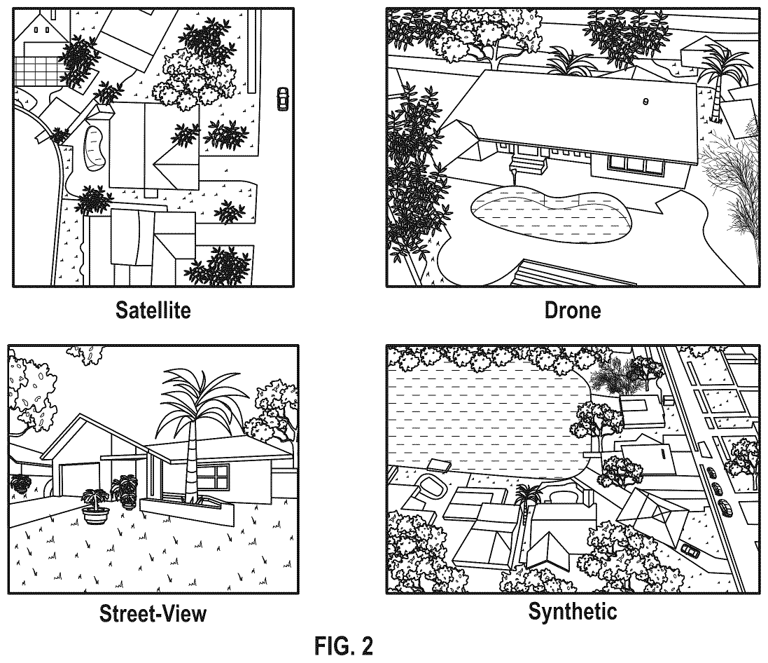

In some embodiments, the “discoverer” is a processing element configured to receive and process raw data. In one example, the “discoverer” scrapes images from unindexed geographic information system (GIS) servers, e.g., the ArcGIS server or other GIS servers maintained by different entities. The data received from the GIS server may have different amounts of boundaries, coverage, and/or image resolution. The “discoverer” may then be configured to perform one or more cleaning and processing steps to the raw data, as will be discussed further in relation to FIG. 2. The cleaned and/or processed raw data may then be stored in one or more image servers, accessible by the “image-exporter”.

In some embodiments, the “image-exporter” is a processing element configured to export images from one or more image servers (e.g., the image servers containing cleaned images from the “discoverer”) and index each of the images with annotated metadata. In some embodiments, the images are indexed with geometric information, such as via an S2 Geometry indexing (e.g., a framework for decomposing the unit sphere into a hierarchy of cells, as described further in <http://s2geometry.io/>). The “image-exporter” is configured to store the exported images in one or more data repositories (accessible via the “image-encoder”).

Additionally, or alternatively, different image modalities are received and processed in a similar way. For example, as shown in FIG. 1, image data from dash cams and/or street view cameras can be cleaned and/or indexed by an adapter module in a similar way as described in relation to the “discoverer” and “image-exporter”. As a further example, oblique GeoTIFF image files (e.g., oblique aerial or satellite imagery captured at an angle to the ground) can be processed by a respective adapter module in a similar fashion. Therefore, additional georeferenced images from different modalities can be stored in one or more data repositories (e.g., the same one or more data repositories in which the “image-exporter” stores the images it processes).

In some embodiments, the “image-encoder” is configured to spatially encode (e.g., spatially embed) the indexed images stored in the one or more data repositories, as will be discussed in further detail below. The encoded images (e.g., a geospatial or vector embedding) can then be used to train one or more machine learning models, as will be discussed below. This allows a machine learning model to learn one or more relationships between an image and a spatial encoding (e.g., in vector space or mesh space), which then allows for quick and accurate predictions to be made regarding a location of an unknown image based on comparisons to a reference data set.

In some embodiments, the “image-encoder”, “image-exporter” and “discoverer” are each implemented via one or more (respective) processing elements, running one or more instructions stored in one or more memory elements.

FIG. 2 illustrates one example of how cross-modal observations (e.g., images from a plurality of different modalities, such as the “Open Source StreetView” and images on the “Image Servers” shown in FIG. 1) are cleaned and aligned. For example, four images from four disparate sources are shown for same property (e.g., a satellite image, a drone image, a street-view image, and a synthetically generated image). In this example, all of the four images were taken within a same period (e.g., within a same year). Therefore, spatio-temporal cross-modal overlap exists between each of the images. Accordingly, each of the images can be indexed and/or annotated in a consistent way such that the images can be linked with one another.

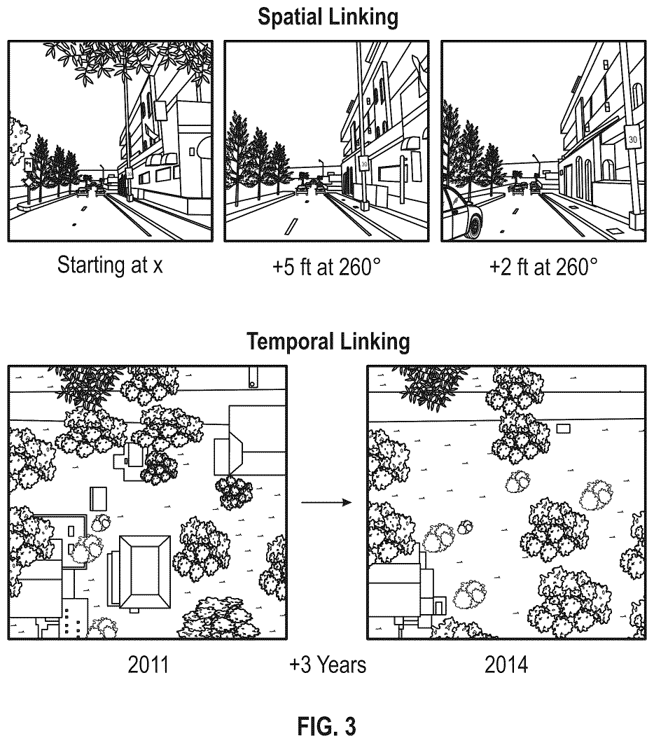

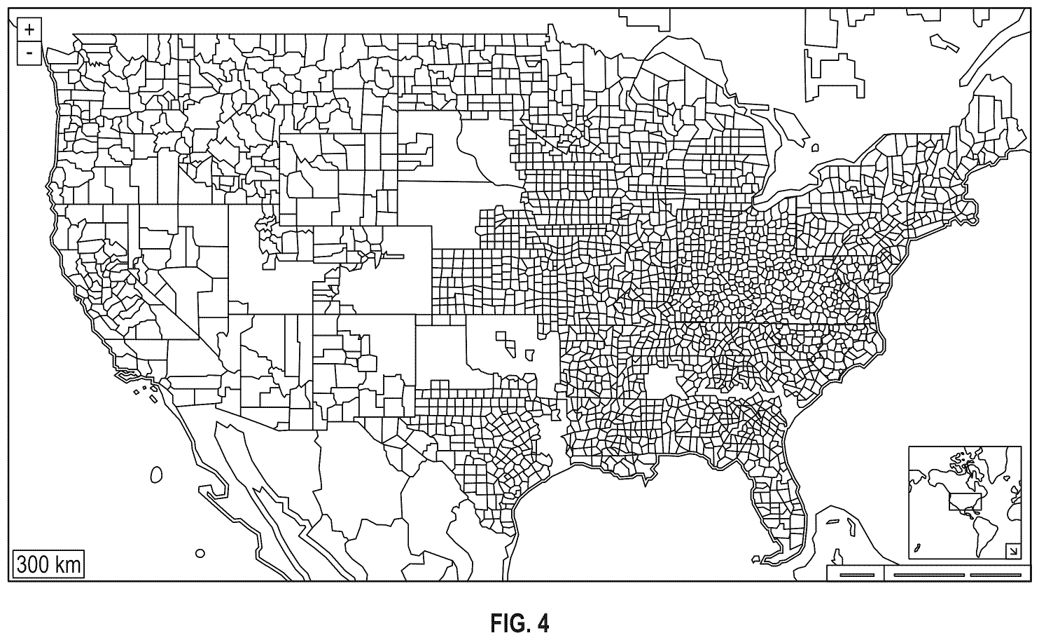

FIG. 3 illustrates one example of how observations from a same modality (e.g., from a single source, or from different sources of a same type, such as multiple images from “Open Source StreetView” shown in FIG. 1) are cleaned and aligned. For example, three images associated with a street-view camera are received at different spatial locations. For example, images are received having +0 feet, +2 feet, and +5 feet (e.g., images taken as the camera is moving). Thus, these images can be spatially linked. As a further example, two images associated with a satellite image are received at different times. For example, one image is taken in 2011, and a later image of the same location is taken 3 years later in 2014. Therefore, these images can be temporally linked. Accordingly, each of the images shown in FIG. 4 can be indexed and/or annotated in a consistent way such that the images can be linked with one another.

As will be discussed in further detail below, one method of the present disclosure relies on spatially encoding (e.g., embedding) a reference data set, and determining a location of an unknown image via comparison to the spatially embedded reference data set. FIG. 4 therefore illustrates an exemplary map of reference data sets that may be generated with different levels of granularity. For example, as shown in FIG. 4, all of California has been mapped and therefore the method can be used to determine a location of an unknown image when used in California. In contrast, the method would not be usable within the unmapped portions of Nebraska and South Dakota, for example. Of course, this map is merely exemplary, and more portions of coverage may be available.

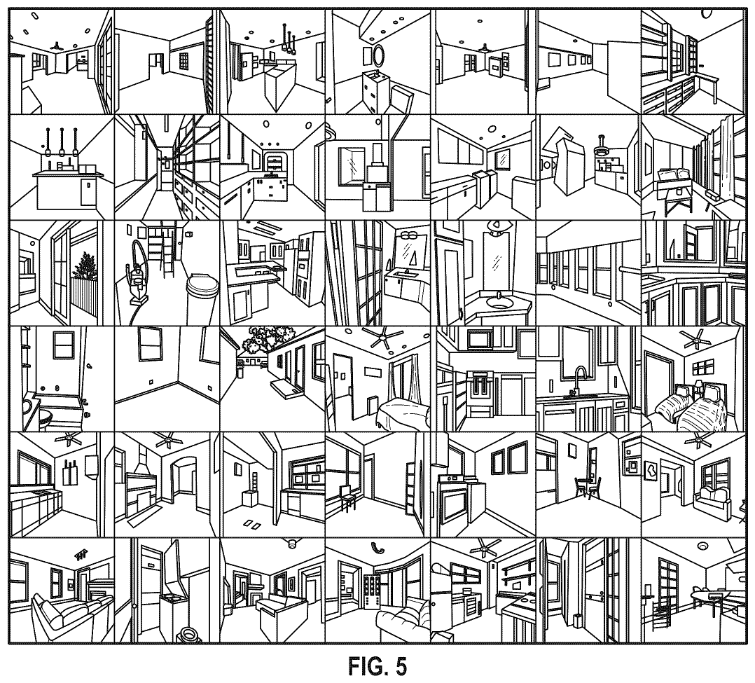

FIG. 5 illustrates exemplary home interior images that may be indexed and cleaned for use with the present method. Therefore, the present method is not merely limited to exterior mapping based on satellite images. In this way, interior spaces may be mapped for use with locating images. As one example, an interior space of a shopping mall may be mapped by generating a reference data set. In the same way, by spatially embedding the reference data set with the same trained model, then the reference data set can be used to locate unknown images by finding the image with the shortest vector distance. This may be helpful, for example, for user or robot/drone navigation in an interior space.

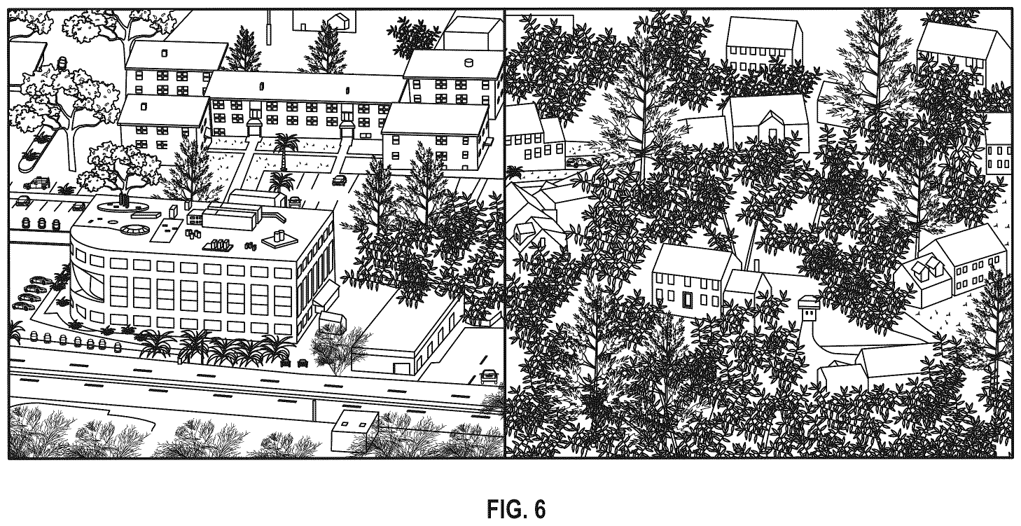

FIG. 6 illustrates a synthetically generated 3D image associated with a real world location. In one embodiment, the synthetically generated 3D image is generated by applying one or more post processing steps (e.g., applying a rotation along one or more axes, applying a translational shift along one or more axes, and/or applying a zooming effect) to an image from one or more real-world modalities. As one example, the synthetically generated 3D image shown in FIG. 6 may be an image that appears to be taken from a 45-degree angle relative to ground, but it may have been generated from an overhead satellite image.

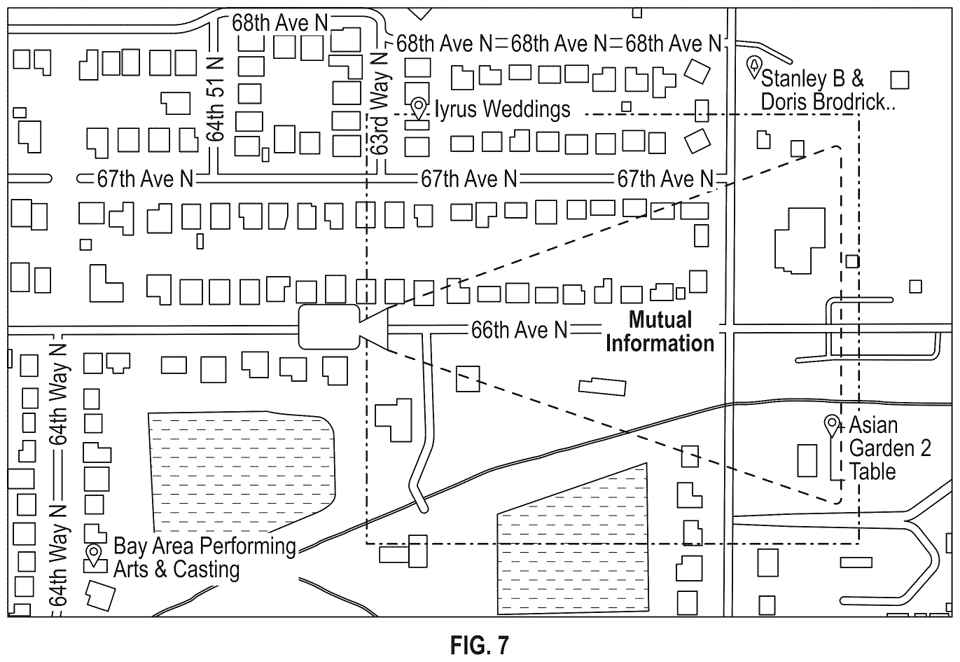

FIG. 7 illustrates a conceptual example of aligning two observations spatially from different image modalities. The triangular boundary reflects the visible information from a street-view image taken from a car driving along a road with a camera. The square boundary reflects an aerial view taken from a satellite image. As shown, there is shared mutual information between the satellite image and the street-view image, and therefore one or more alignment steps can be taken to link these images (e.g., by applying a same metadata annotation so that the images can be associated with one another).

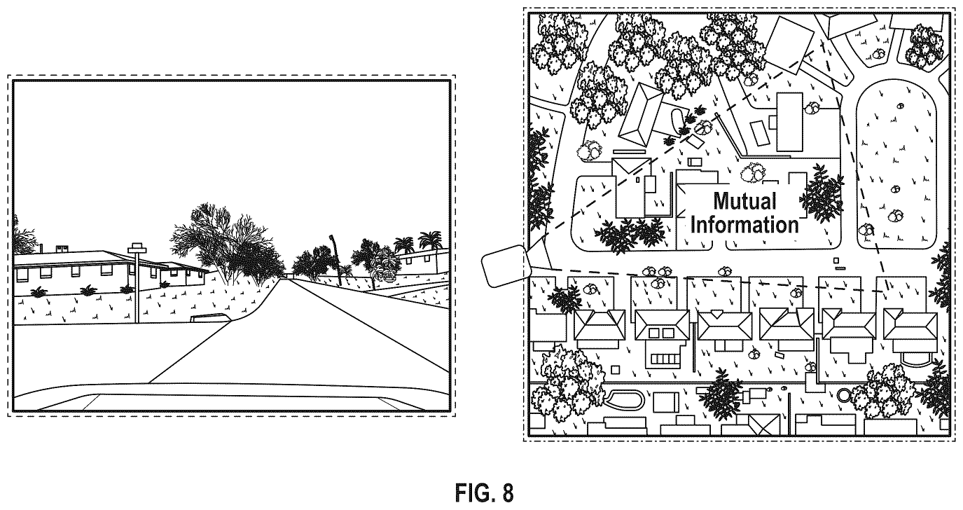

FIG. 8 illustrates a real-world example of FIG. 7. In the left image, an exemplary street-view image is shown, and in the right image an exemplary satellite image is shown. The mutual information is also shown by the overlaid triangular outline on the satellite image. This alignment may be performed via contrastive alignment. As will be discussed further in relation to the below method, such an alignment process enables an improvement in CM level (centimeter-level) positioning, which was previously only possible using GNSS techniques.

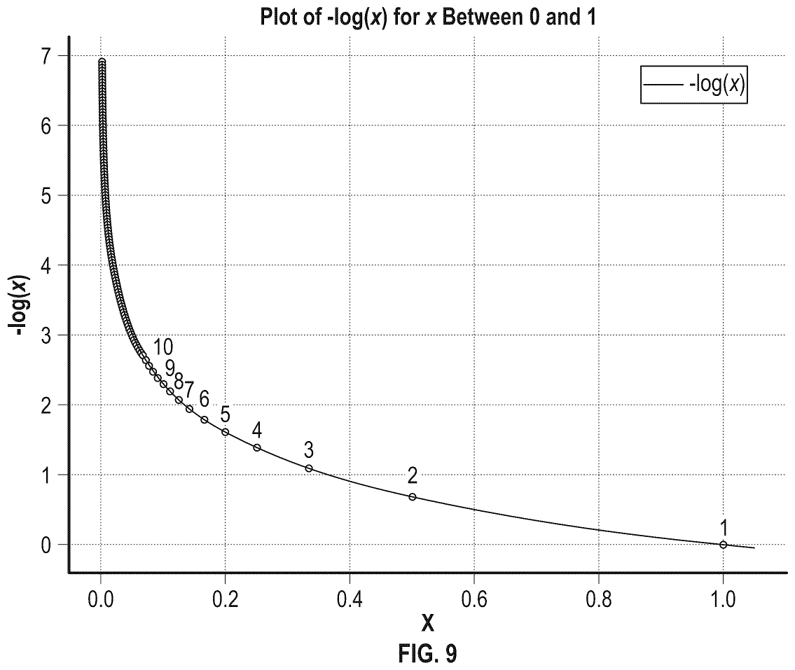

FIG. 9 illustrates an exemplary duplicate positive masking function used during training of a machine learning model. Such a masking function prevents an exponentially increasing amount of error from biasing the model when multiple observations of the same location are seen during training.

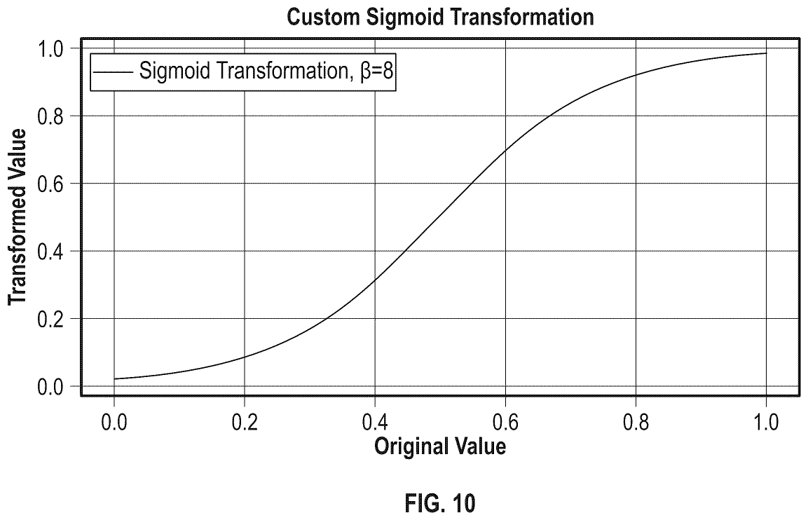

FIG. 10 illustrates an exemplary custom sigmoid real-world loss scaling function that may be used during training of a machine learning model. Such a function increases the model's penalty for aligning images which are far apart from each other in the real world.

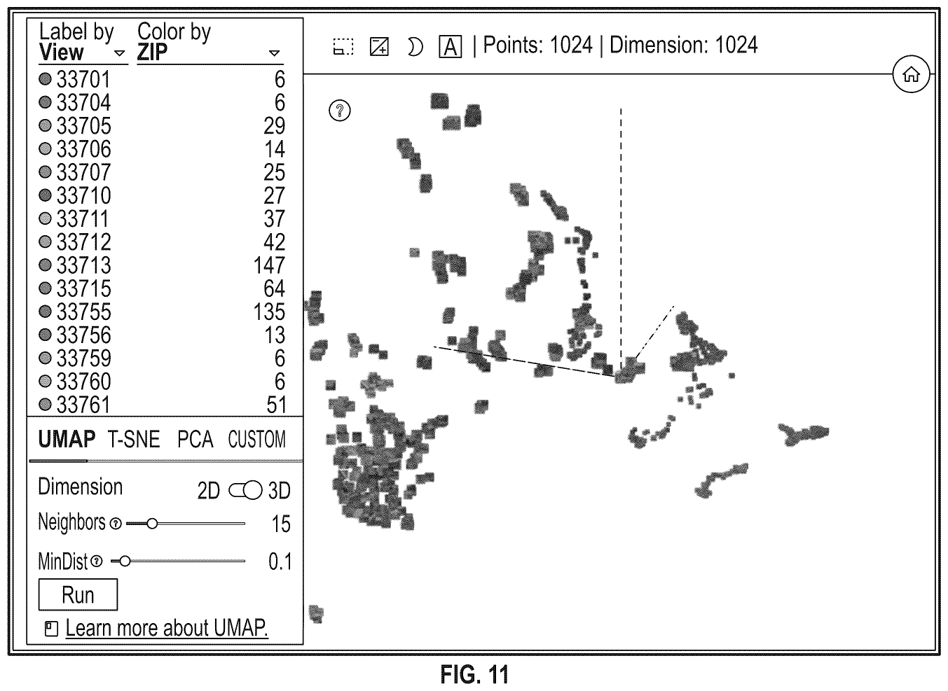

FIG. 11 illustrates an exemplary visualization of the embedding space of a machine learning model according to the present disclosure. As illustrated, the colors represent zip codes, the model places real-world nearby samples together.

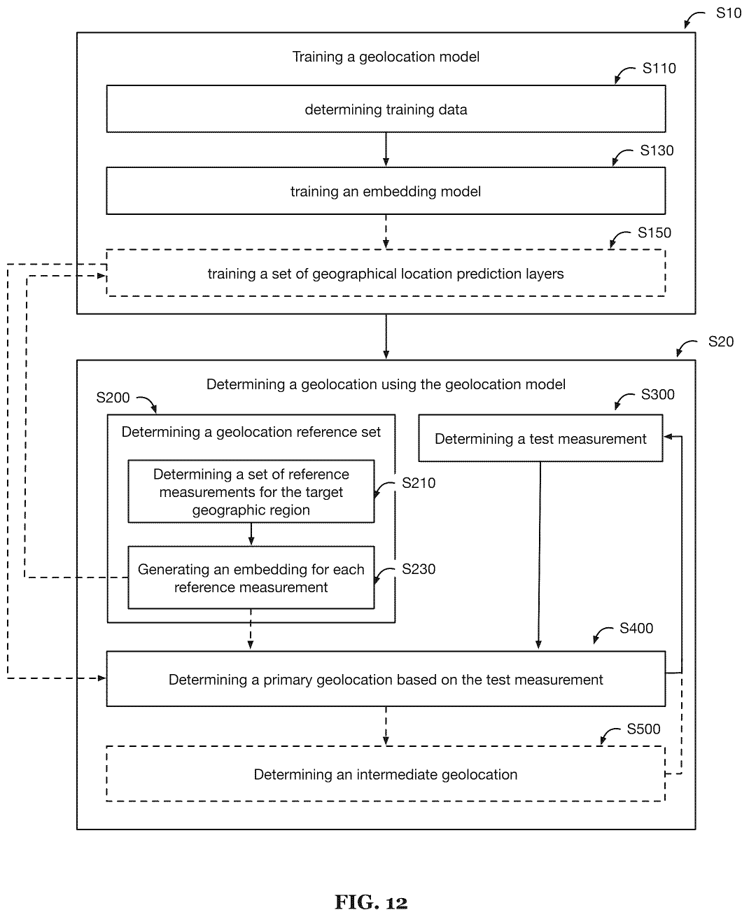

The following sections describe a specific method according to embodiments of the disclosure for training and using a machine learning model (e.g., a geolocation model S10), as will be described further in relation to FIGS. 12-19.

### 1. Overview

As shown in FIG. 12, the method can include: training a geolocation model S10; and determining a geolocation using the geolocation model S20. The method functions to geolocate a measurement.

In an illustrative example, the method can include: sampling a monocular image of a region adjacent a vehicle; encoding (e.g., embedding) the image into a spatially consistent latent space using a trained encoding (e.g., embedding) model; and determining a primary geolocation for the monocular image based on the encoding (e.g., embedding) (e.g., by comparing the image embedding with predetermined image embeddings for a plurality of geolocations). In variants, the primary geolocation can be incrementally updated using pose changes estimated using odometry (e.g., visual odometry). In variants, the encoding (e.g., embedding) model can be trained to encode (e.g., embed) images into the spatially consistent latent space through contrastive learning, using a custom loss function, such as the sigmoid loss function shown in FIG. 10, that embeds images of physically adjacent locations proximal each other in latent space (e.g., the difference between image embeddings is related to the difference in the respective physical locations). However, the method can be otherwise performed.

In some embodiments, the encoding steps of the method are achieved via the “image-encoder” described above in relation to FIG. 1.

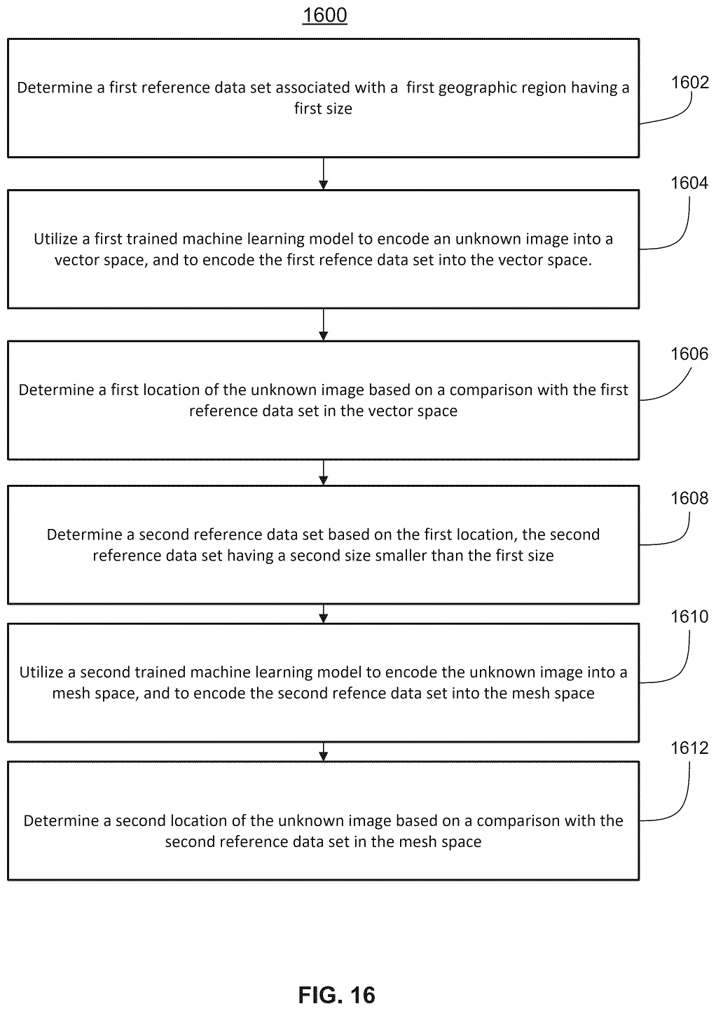

In some embodiments, encoding the image comprises a vector encoding. In some embodiments, encoding the image comprises a mesh encoding, as will be discussed further in relation to FIG. 16.

### 2. Technical Advantages

Variants of the technology can confer one or more advantages over conventional technologies.

First, variants of the technology train an embedding model to learn a spatially consistent latent space, wherein inter-embedding distances are proportional to correspond to real-world geographic distances. This approach can enable more accurate location estimation without requiring explicit geographic coordinates during training. For example, the system can learn spatial relationships between locations based on visual similarities and differences, creating a more natural and intuitive representation of geographic space. The embedding-based approach can reduce the computational complexity typically associated with traditional geographic coordinate systems.

Second, variants of the technology can perform accurate geolocation across varying perspectives and partial imagery of the same region. This capability can enhance the robustness and reliability of the system in real-world applications. For example, the system can successfully determine location using images taken from different angles, heights, or distances, or even from small sections of high-texture imagery. This flexibility can enable location determination in challenging scenarios where conventional systems may fail due to perspective limitations or incomplete visual information.

However, further advantages can be provided by the system and method disclosed herein.

### 3. Method

As shown in FIG. 12, the method can include: training a geolocation model S10; and determining a geolocation using the geolocation model S20. The method functions to geolocate a measurement.

All or portions of the method can be performed by a remote computing system (e.g., cloud compute, remote server, etc.), a local computing system (e.g., onboard the vehicle, an edge computing device, etc.), and/or in any other location.

In some embodiments, the geolocation model S10 comprises a transformer-decoder model.

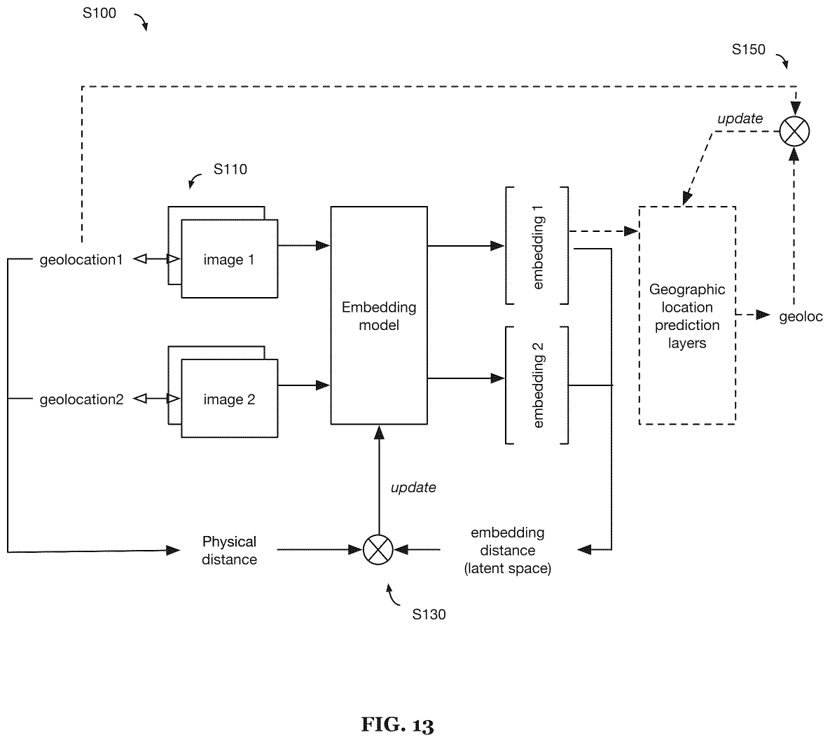

Training a geolocation model S10 functions learn an internal representation of the physical world. In an example, S10 can train a model with a spatially consistent latent space, in which latent embedding distances are proportional to physical distance. An example is shown in FIG. 13. S10 can be performed: once, for every new geographic region, for new modalities, for new location classes (e.g., urban vs. rural; interior vs. exterior; etc.), and/or when any other training condition is met.

In variants, training a geolocation model S10 includes determining a set of training data S110; training an encoding (e.g., embedding) model S130; and optionally training a set of geographic location prediction layers S150. However, the geolocation model can be otherwise trained.

Determining a set of training data S110 functions to determine training data to train the embedding model.

The training data can include a set of geolocated measurements of one or more physical regions, and/or include other information. The training measurements can include earth observational data (e.g., satellite measurements, drone measurements, terrestrial vehicle measurements, etc.); city records (e.g., survey data, ARCGIS, etc.); real estate data (e.g., interior imagery; exterior imagery; etc.); synthetic data; and/or any other data. In an example, training measurements can include GIS data, dash cam data, streetview data, oblique geotiff data, and/or any other measurements (e.g., as described above in relation to FIG. 1). The training measurements can be: images (e.g., RGB, IR, multispectral, hyperspectral, UV, etc.), acoustic measurements (e.g., sonar, etc.), electromagnetic measurements (e.g., radar), point clouds (e.g., LIDAR measurements, etc.), and/or have any other modality. In some embodiments, the training measurements may be geolocated (e.g., a location associated with a satellite measurement or a depth measurement from a depth sensor corresponding to an underwater terrain depth associated with an acoustic measurement). The training measurements can be in a single perspective or be in multiple perspectives (e.g., oblique, orthographic, etc.). The measurements can be the same or different perspective as that used by the test measurements. In an example, the measurements can include a wide distribution of perspectives, such that the embeddings are sensor angle-invariant. In another example, the measurements can be from the same or different perspective as the test measurements used in inference. The measurements can be zoomed, flipped, rotated, cropped, and/or otherwise processed to enhance the training data distribution and diversity. The training measurements can be sampled (e.g., by sensors onboard a secondary vehicle, sensors onboard the vehicle), retrieved (e.g., scraped), and/or otherwise obtained.

The training measurements can depict the same or different type of environment as the test measurements during inference. In a first example, the measurements can depict interior imagery when the use case is for geolocating using exterior imagery. In a second example, the measurements can lack desert imagery when the use case is for geolocating in the desert. For example, the machine learning model can be trained to learn a relationship between an image and a spatial embedding, and therefore a trained model can be used to apply this relationship to images that are different from the training data set.

The measurements can be of the same or different geographic region as the use case. In an example, the measurements can be trained on data from America (e.g., without any European imagery), but used in Europe. For example, the training data can be used to train a machine learning model to spatially embed data into a vector space and/or a mesh space. Accordingly, once this relationship is learned by the machine learning model, further processing can be performed to geolocate an image (e.g., by comparing an embedded vector associated with an image with an unknown location against other embedded vectors from a reference data set). Therefore, the model can be trained on data from America, but then applied to locating in Europe (when a European reference data set is processed by the model).

Geographic labels can be associated with the measurements. The geographic labels can be: geolocation data (e.g., geographic coordinates), relative distances, and/or any other labels. The geolocation data can include geospatial identifiers (e.g., latitude/longitude, region ID, addresses, S2 cell index, etc.) and/or any other geolocation data.

The measurements can be used alone or in training sets (e.g., training pairs). In a first example, multiple training sets can be generated from the measurement set, wherein each training set includes two or more measurements, and is associated with a distance label (e.g., determined from the physical distance between the geographic locations associated with the measurements in the training set). In one example, the distance label is not provided by a user, but rather is determined via a self-supervised training technique in which the machine learning model determines the distance label for training. In a second example, the set of measurements can be split into positive pairs and negative pairs (e.g., for contrastive learning). In this example, positive pairs can include images of geographic regions closer than a threshold physical distance and negative pairs can include images of geographic regions farther than a threshold physical distance. However, the positive and negative pairs can be otherwise defined.

In variants, pairs of measurements from identical spatial locations can be masked or removed, which can prevent these pairs from impacting the contrastive learning as negative pairs (masked spatial contrastive).

In variants, similar measurements (e.g., visually-similar imagery) that were captured in different geolocations can be used to increase the contrastive training difficulty, and thus boost the performance and generality of the system (e.g., hard negative mining).

However, determining a set of training data s110 may be otherwise performed.

Training an encoding (e.g., embedding) model S130 functions to train the encoding (e.g., embedding) model to learn a geospatial encoding (e.g., embedding) space where encoding (e.g., embedding similarity) reflects geographic proximity (e.g., geographic similarity).

The embedding model can be or include a set of embedding layers, a ViT, the embedding layers of a convolutional neural network (CNN), the embedding layers of a DNN, an encoder, and/or any other embedding model components. The embedding model can be a spatial model, spatiotemporal model, and/or any other model. The embedding model is preferably generalizable to any geographic region (e.g., outside of the training data set), but can alternatively be specific to the training geographic region.

In some embodiments, the encoding (e.g., embedding) model is implemented via one or more processing elements, running one or more instructions stored in one or more memory elements (e.g., by executing a computer-readable medium storing the one or more instructions). In some embodiments, the encoding model shares one or more characteristics with the “image-encoder” described in relation to FIG. 1.

The embedding model preferably generates (e.g., predicts) the embedding based on the measurement alone, but can additionally or alternatively generate the embedding based on measurement metadata (e.g., intrinsic sensor parameters, sensor pose relative to gravity, etc.), features extracted from the measurements (e.g., edge detections, shape detections, blob detections, object detections, etc.), and/or other information.

The embedding model is preferably trained using contrastive learning, but can alternatively be trained using supervised learning, and/or any other training method.

The embedding model can be trained using a custom loss that biases the embedding distance to approximate the physical distance (e.g., to match the physical distance, to match a scaled version of the physical distance, to match a normalized version of the physical distance, to approximate the physical distance, etc.), but can alternatively use any other loss.

The embedding model can optionally additionally be trained using a temporal loss. In variants, the samples of the same spatial location can be aligned or repelled in the temporal dimension, allowing for robust training against or towards temporal changes in the same geographic location. In an example, images of the same geographic location from 2000, 2010, and 2020 can be aligned (e.g., a loss computed based on embeddings of the respective images should be small or 0), such as is illustrated by the temporal linking illustrated in FIG. 3.

In a first variant, training the embedding model can include: embedding a first and second measurement into a first and second embedding, respectively, using the embedding model; determining a latent distance between the first and second embedding; determining a physical distance (e.g., absolute distance, relative distance, etc.) between a first and second geolocation associated with the first and second measurements, respectively; computing a loss that forces the embedding distance to approximate the physical distance (e.g., using a contrastive loss function, using a spatial loss function, (e.g., the loss function shown in FIG. 10) etc.); and updating the embedding model based on the loss (e.g., using backpropagation, etc.). In an example, the loss can be computed as L=(∥zᵢ−zⱼ∥₂˜|sᵢ−sⱼ|)², where zᵢ, zⱼ are measurement embeddings and sᵢ, sⱼ are geographic locations. In an example, computing the loss can include computing a latent distance between the embeddings, then comparing the latent distance against the physical distance between the geographic locations associated with the first and second measurements. In a first embodiment, the physical distance between latent embeddings in the latent space can only represent relative physical positions. In a second embodiment, the physical distance between latent embeddings in the latent space can also represent relative physical orientation (e.g., the loss function relates the pose between latent embeddings to the physical pose between the geographic regions). However, the loss can be otherwise defined.

In a second variant, S130 can include: computing embeddings for the measurements in each positive or negative training set (e.g., using measurement embeddings of close locations and far locations), using the embedding model; computing a contrastive loss based on the respective embeddings (e.g., Info NCE, triplet loss, etc.); and updating the embedding model based on the contrastive loss.

In variants, the loss can be smoothed based on the real-world distance (e.g., real-world distance based loss smoothing). In an example, this can organize the embeddings into a spatially consistent latent space, such as is illustrated in FIG. 11.

However, the embedding model may be otherwise trained.

Training the geolocation model can optionally include training a set of geographic location prediction layers S150, which functions to predict a geographic location based on the measurement embeddings output by the embedding model.

The geolocation model can include or exclude the geographic location prediction layers. In a first variant, the geolocation model can only include the embedding model, wherein geolocation can be performed using a distance or similarity score between the output embeddings. In a second variant, the geolocation model can include the embedding model and the set of geographic location prediction layers, wherein the set of geographic location prediction layers can predict a geolocation given the embeddings output by the embedding model.

When the geolocation model includes geographic location prediction layers, the geographic location prediction layers can include a classification head, decoder, secondary model, ViT, DNN, CNN, and/or any other layers. The geographic location prediction layers are preferably trained on training data from the geographic region that the model will be used in (e.g., target geographic region, the region that the vehicle is traversing in S20, etc.), but can alternatively not be trained on training data from the inference geographic region. In an example, the geographic location prediction layers can be trained on the set of reference measurements from S210. In some embodiments, the set of reference measurements (e.g., a reference data set) is different from the training data. In some embodiments, the set of reference measurements (e.g., a reference data set) includes different data from the training data, but includes a same type of data. For example, for exterior image location, the training data set and the reference data set each include a respective plurality of geolocated exterior images. As another example, for interior image location, the training data set and the reference data set each include a respective plurality of geolocated interior images, such as illustrated in FIG. 5. The same may also be true for other types of maps (e.g., sonar maps in underwater environments)

S150 can include: receiving a measurement embedding for a measurement from the embedding model; predicting a geographic location (e.g., set of geocoordinates) based on the measurement embedding with the set of geographic location prediction layers; comparing the predicted geographic location and the geographic location associated with the measurement (e.g., computing a loss between the predicted and actual geographic location); and updating the geographic location prediction layers based on the comparison.

However, training a set of geographic location prediction layers S150 may be otherwise performed.

However, training a geolocation model S10 may be otherwise performed.

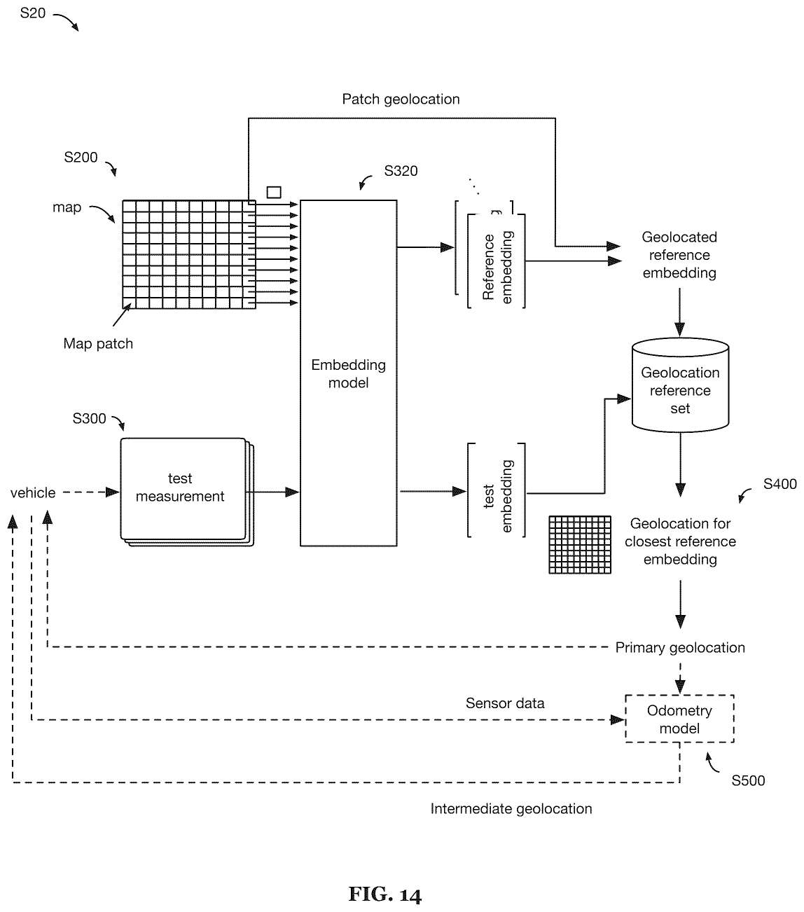

Determining a geolocation using the geolocation model S20 functions to determine a geolocation depicted in the test measurement (e.g., geoposition the test measurement). An example is shown in FIG. 14.

S20 can determine a geolocation for a vehicle, a measurement, and/or any other entity. In an example, S20 can determine the ego location for a vehicle based on measurements sampled by the vehicle. In an example, types of vehicles that can be used include terrestrial vehicles (e.g., automobiles, commercial vehicles, trucks, vans, etc.), aerial vehicles (e.g., UAVs, aircraft, drones, etc.), aquatic vehicles (e.g., ships, drones, etc.), and/or any other vehicles.

All or parts of S20 can be performed: every time a new measurement is received, continuously, periodically, at a predetermined frequency, during entity operation, and/or at any other time. In an example, determining a test measurement S300, geolocating the test measurement S400, and determining intermediate locations S500 (e.g., using odometry to infer ego pose between geolocations) can be repeated throughout vehicle operation.

In variants, S20 can operate only using passive measurements (e.g., imagery, IMU data, etc.). This can be useful in GPS-denied environments or active sensing-denied operation contexts (e.g., contexts where active sensors, such as LIDAR, cannot be used for geolocation) and/or any other environments. Alternatively, S20 can operate using active measurements.

In variants, determining a geolocation using the geolocation model S20 includes determining a geolocation reference set S200; determining a test measurement S300; determining a primary geolocation based on the test measurement S400; and optionally determining an intermediate geolocation S500. However, the geolocation can be otherwise determined.

Determining a geolocation reference set S200 functions to provide a ground truth geographic reference for subsequent geolocation. S200 can be performed before S300, before S400, when training, at the start of inference, and/or at any other time. S200 can be repeated when every time the model is being used for a new geographic region (e.g., new geographical areas, etc.), and/or any other time.

In variants, determining a geolocation reference set S200 includes determining a set of reference measurements for the target geographic region S210; and generating an embedding for each reference measurement S230.

Determining a set of reference measurements for the target geographic region S210 functions to provide ground-truth measurements for the target geographic region that the entity will be located within. The target geographic region can be within the training data set for the geolocation model (e.g., the embedding model) or outside of the training data set. The set of reference measurements is preferably from a different perspective as the test measurements (e.g., used in S300), but can alternatively be from the same perspective (e.g., be orthographic data while the test measurement is oblique). The set of reference measurements can include a set of measurements associated with geolocation data, metadata, and/or other data. The geolocation data can include geospatial identifiers (e.g., latitude/longitude, region ID, addresses, S2 cell index, etc.) and/or any other geolocation data. The metadata can include timestamps, measurement modality, measurement perspective (e.g., aerial, street-level, oblique), scene type (e.g., urban, coastal, vegetation, etc.), quality scores, source labels, filenames, and/or any other metadata. The set of reference measurements can be real-world measurements, synthetic measurements, and/or any other measurements. The set of reference measurements can be in a single modality (e.g., RGB imagery), but can alternatively include multiple modalities, such as is described in relation to FIG. 1.

In an example, S210 can include generating the set of reference measurements from a map (e.g., orthographic measurement; sampled from a top-down perspective; etc.), wherein each reference measurement is a map patch (e.g., map unit, map chip, etc.). The map can be a satellite image, topographic map, street map, land use map, weather map, and/or any other map type. The map can be a real-world map, synthetic map (using CCM tools such as CityEngine), and/or any other map format. The map is preferably a visual map (e.g., RGB, multispectral, hyperspectral, etc.), but can alternatively be a 3D map (e.g., set of point clouds, set of hulls, etc.). The map is preferably 2D, but can alternatively be 3D. Each map patch can be associated with the geolocation(s) encompassed by the map patch, but can alternatively be associated with any other location. The map patches can be uniform, nonuniform, evenly distributed (e.g., arranged in a grid), unevenly distributed, and/or any other distribution. The size of the map patches can be predetermined (e.g., represent a 1 m×1 m patch of ground, be N pixels wide, etc.), be dynamically determined (e.g., determined based on the size of the map, determined based on the size of the physical region represented by the map, determined based on the context length of the embedding model, determined based on the desired geopositioning resolution, etc.), be determined based on heuristics, and/or any other determination method. In an example, S210 can include splitting the map into a grid of map patches, such as is illustrated by FIG. 4.

In a second variant, S210 can include sampling a set of oblique images of the target geographic region. In an example, S210 can include driving a preliminary vehicle through the geographic region, sampling measurements en route, and associating the measurements with the respective GPS location.

However, S210 may be otherwise performed.

Generating an embedding for each reference measurement S230 functions to represent each reference measurement in the latent space. The generated embeddings can serve as a reference for test image embedding matching or as training inputs for the geographic location prediction layers. S230 preferably includes embedding each reference measurement from the set into latent embeddings (e.g., reference embeddings in the spatially consistent latent space using the trained embedding model (e.g., the same embedding model used in S200), but can alternatively be generated using another encoder (e.g., contrastive encoder, etc.), or otherwise performed. The resultant reference embeddings are preferably stored in association with the respective reference measurement's geolocation data, but can be otherwise managed. The reference embeddings can be stored onboard the vehicle, in a remote database, and/or any other storage location.

However, S230 may be otherwise performed.

However, determining a geolocation reference set s200 may be otherwise performed.

Determining a test measurement S300 functions to obtain measurements of an unknown geolocation adjacent the vehicle. S300 can be performed after S200, and/or at any other time. S300 is preferably repeated during vehicle operation (e.g., during vehicle traversal through the geographic region), but can alternatively be performed after vehicle operation (e.g., to geoposition the vehicle's measurement after the fact). S300 can be performed continuously, periodically (e.g., when new footage is available), at a predetermined time, and/or at any other time.

The set of test measurements is preferably sampled by sensors onboard a vehicle traversing through the environment, but can alternatively be retrieved or otherwise determined. The set of test measurements can have the same or different perspective from the reference measurements. In an example, the map can be an orthographic map and have a top-down view, while the test image can be an oblique image and have a front-facing view. The set of test measurements is preferably in the same measurement domain as the map (e.g., a visual image when the map is a visual map), but can alternatively be in a different domain.

However, S300 may be otherwise performed.

Determining a primary geolocation based on the test measurement S400 functions to use the trained geolocation model to determine the geolocation of the test measurement (e.g., of the vehicle sampling the test measurement). S400 can be performed after S10, S200, S300, and/or any other steps. S400 can be performed periodically, continuously, and/or at any other time. S400 preferably returns geolocation data associated with the geographic region depicted in the measurement (e.g., geographic coordinates, S2 cell identifier, etc.), but can alternatively return other information.

S400 preferably includes: determining a test embedding for the test measurement (e.g., using the same embedding model as S300, etc.); and determining the geolocation for the test measurement based on the test embedding, but can alternatively be otherwise performed.

Determining the test embedding for the test measurement functions to embed the test measurement into the spatially consistent latent space. The test measurement embedding can be determined using the trained geolocation model (e.g., the trained embedding model), using the same embedding model as that used in S230, and/or using any other model.

Determining the geolocation based on the test embedding can include: matching the test embedding against reference embeddings, predicting the geolocation based on the test embedding, and/or otherwise determining the geolocation.

In a first variant, S400 can include geolocating the test measurement by comparing the test embedding for the test measurement against the reference embeddings for the reference measurements, and returning the geographic data (e.g., geolocation) for the reference measurements with the closest embedding(s) (e.g., as determined using a similarity score or distance score, such as cosine similarity). The set of reference measurement embeddings used for the comparison can include all reference measurement embeddings or a subset of the reference measurement embeddings. In an example, the set of reference measurement embeddings can be constrained to a geographic region determined using odometry, wherein the test measurement embedding is only compared against reference measurement embeddings within a high-probability zone, determined based on vehicle odometry.

In a second variant, S400 can include predicting a geolocation based on the test measurement embedding, using a set of geographic location prediction layers trained to predict the reference measurement geolocations given the reference measurement embeddings.

In a third variant, S400 can include determining the current geolocation based on a distance between the current test measurement embedding and a prior measurement embedding. The prior measurement embedding can be the embedding for: the prior vehicle measurement, a reference measurement, and/or any other measurement. In a first example, the geolocation can be regressed based on the latent embedding distance. In a second example, the geolocation can be determined by determining a latent distance between the embedding for the prior measurement and the embedding for the current test measurement; converting the latent distance to a physical distance (and/or change in pose) (e.g., based on a scaling factor, conversion factor, etc.); modifying a prior geolocation associated with the prior measurement embedding with the determine physical distance and/or change in pose.

However, determining a primary geolocation based on the test measurement S400 may be otherwise performed.

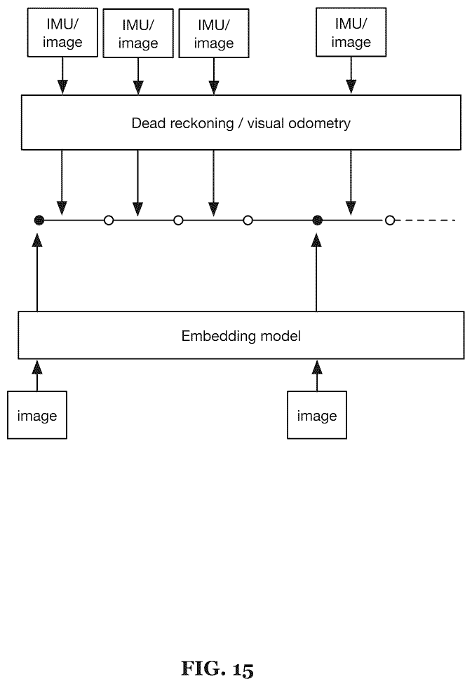

The method can optionally include determining an intermediate geolocation S500, which functions to estimate the vehicle geolocation between precise location determinations (e.g., between instances of S400). An example is shown in FIG. 15. S500 is preferably performed between instances of S400, but can alternatively be performed when S400's prediction falls below a threshold confidence level, and/or at any other time. In variants, interleaving S500 with instances of S400 can be particularly helpful when S400 takes longer than a threshold time (e.g., time interval between a desired geolocation update frequency).

In variants, the intermediate geolocations can be determined based on the last precise geolocation (e.g., from S400) and a pose change determined based on secondary sensor data, or otherwise determined. The secondary sensor data can be the same or different modality from the test measurement. Examples of secondary sensor data that can be used include images, kinematic data (e.g., IMU data, etc.), wheel odometry, motor odometry, and/or any other sensor data.

The pose change can be determined using visual odometry (e.g., estimating motion by tracking visual features between image frames), wheel odometry (e.g., measuring distance traveled based on wheel rotations and robot geometry), inertial odometry (e.g., integrating linear acceleration and angular velocity over time), RGB-D odometry (e.g., tracking movement using both images and depth), lidar odometry (e.g., track motion by matching consecutive LiDAR scans), dead reckoning, and/or any other pose determination method.

In a first example, the pose change can be predicted using a transformer model trained to predict a position difference based on LIDAR scans (e.g., LIDAR point clouds).

In a second example, the pose change can be predicted based on a sliding window of the historical image stream.

However, determining an intermediate geolocation S500 may be otherwise performed.

However, determining a geolocation using the geolocation model S20 may be otherwise performed.

Optional elements, which can be included in some variants but not others, are indicated in broken line in the figures.

A machine learning model can be used to spatially encode an image into either a vector space or a mesh space. There are unique benefits associated with vector encodings and mesh encodings for the purposes of location detection. Firstly, a mesh encoding may be computationally more complex than a vector encoding and so determining a location based solely upon mesh encodings may not be appropriate for a large reference data set. However, one benefit of a mesh encoding is a higher level of granularity and more accuracy than is achievable via vector encoding alone. In contrast, a vector encoding is computationally less rigorous but may have less accuracy. Therefore, for the purposes of location detection, the best of both encodings may be relied upon for location detection, by first performing a coarse location detection based on a vector-encoded reference data set. Then, once the location of the target image has been determined using vector encoding methods, a mesh encoding method is used to fine-tune the location. In some embodiments, once the coarse location is determined, a second reference data set is selected based on the estimated location, and the second reference data set is encoding into a mesh space for fine alignment. This prevents the need for mesh-encoding an entire reference data set which would be computationally prohibitive.

With reference to FIG. 4, the highlighted segments illustrate the image sets from a first reference data set used for the coarse alignment method using vector encodings. Then, afterwards, a subset of the first reference data set can be used for a second reference data set for fine alignment.

FIG. 16 illustrates a flowchart for utilizing two different types of encodings sequentially for improving location detection. Method 1600 comprises steps 1602 through 1612. Step 1602 includes determining a first reference data set associated with a first geographic region having a first size (such as is shown by step S200 in FIG. 3). Step 1604 includes utilizing a first trained machine learning model to encode an unknown image into a vector space (such as is illustrated by the “image-encoder” shown in FIG. 1, and the embedding model described in relation to FIGS. 12 to 14), and to encode the first refence data set into the vector space. Step 1606 includes determining a first location of the unknown image based on a comparison with the first reference data set in the vector space. Therefore, steps 1602 through 1606 relate to a coarse alignment, and may share one or more features described in relation to method 1900.

Step 1608 includes determining a second reference data set based on the first location, the second reference data set having a second size smaller than the first size. Step 1610 includes utilizing a second trained machine learning model to encode the unknown image into a mesh space, and to encode the second refence data set into the mesh space. Step 1610 includes determining a second location of the unknown image based on a comparison with the second reference data set in the mesh space. Therefore, steps 1068 through 16812 relate to a fine alignment of location.

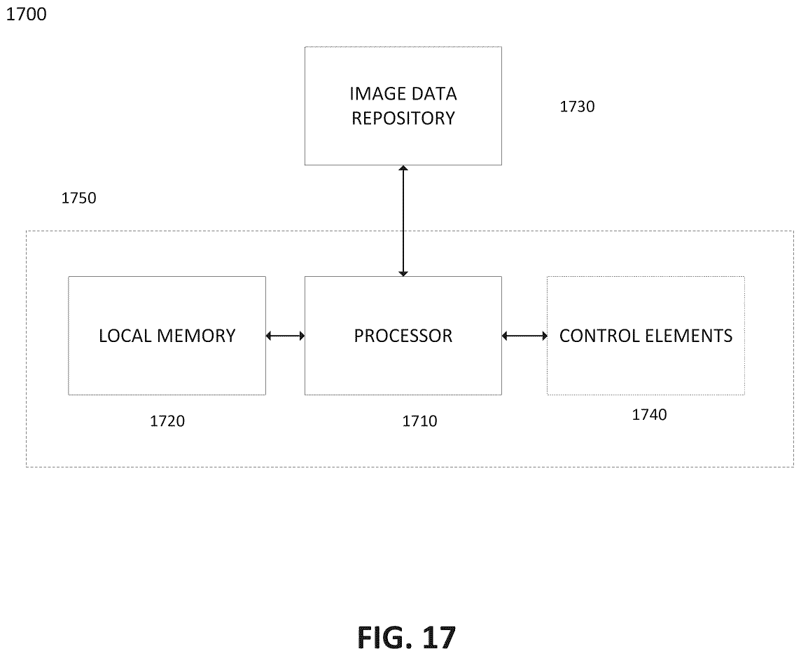

FIG. 17 illustrates an exemplary hardware architecture used for implementing the methods according to an embodiment of the disclosure. The exemplary hardware architecture 1700 includes one or more processors 1710 in electrical communication with one or more local memory elements 1720, and optionally one or more image data repositories 1730. In some embodiments, images present within a reference data set are retrieved from the one or more image data repositories 1730 and loaded into the one or more local memory elements 1720. In some embodiments, the one or more local memory elements 1720 store the embedded image data of the reference data set. Optionally, in some embodiments, the one or more processors 1710 is in electrical communication with one or more control elements 1740 (e.g., for connecting to an action model and controlling one or more motors for directing an autonomous device). In some embodiments, the processors 1710 are configured to perform the function of the “discoverer”, “image-exporter”, and “image-encoder” described in relation to FIG. 1, and/or the embedding model shown and described in relation to FIGS. 12 to 14.

In some embodiments, the one or more local memory elements 1720 and the one or more processors 1710 are implemented on a same computer system 1750. In some embodiments, the one or more control elements are implemented on the same computer system 1750. In some embodiments, the processor is in electrical communication with the one or more local memory elements 1720, the one or more image data repositories 1730, and/or the one or more control elements over a wired or wireless communication link. In some embodiments, the wired communication link includes USB, Ethernet, RS232 or any other comparable communication standard. In some embodiments, the wireless communication link includes WiFi, Bluetooth, Zigbee or any other comparable communication standard.

In some embodiments, the one or more local memory elements 1720 includes the indexed data repository described in relation to FIG. 1.

In some embodiments, the one or more image data repositories 1730 comprise the GIS servers described in relation to FIG. 1. In some embodiments, the one or more image data repositories 1730 comprise data repositories including dash cam images, open source streetview images, and/or oblique geoTIFF data describe in relation to FIG. 1.

In some embodiments, the processor is configured to provide the functionality of “discoverer”, “image-exporter”, and “image-encoder” described above in relation to FIG. 1. In some embodiments, the processor is configured to perform the functionality of the machine learning model that spatially embeds images into a vector space (optionally in conjunction with the one or more local memory elements 1720, such as a random-access memory (RAM)). In some embodiments, the processor is configured to execute a non-transitory computer-readable medium stored in the one or more local memory elements 1720, the computer-readable medium including computer-executable instructions to provide the steps of the “discover”, “image-exporter”, and “image-encoder”shown in FIG. 1.

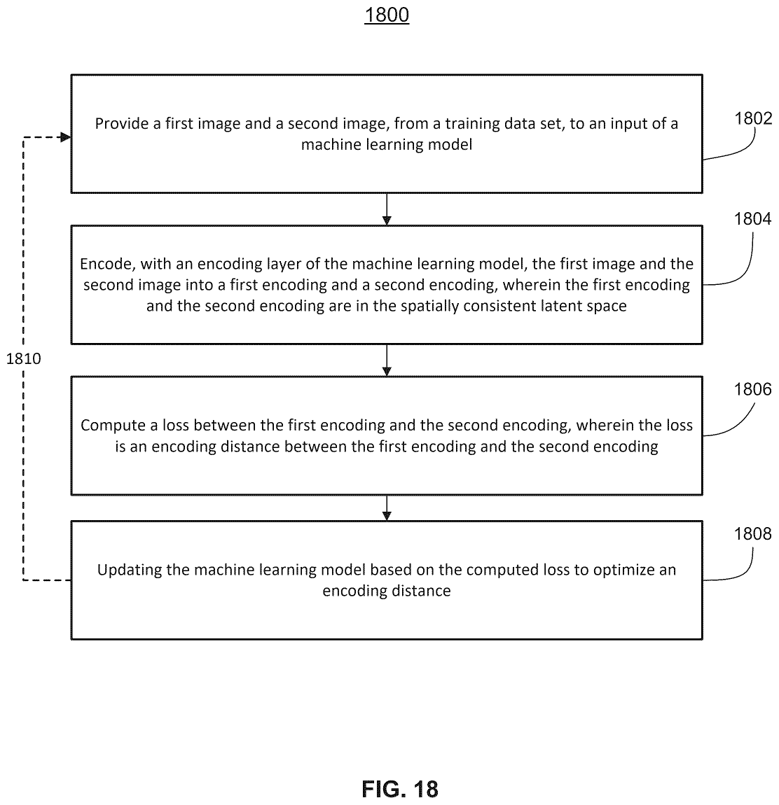

FIG. 18 is a flowchart depicting an exemplary method for training a machine learning model according to the disclosure (e.g., to achieve step of training a geolocation model S10 as shown and described in relation to FIGS. 12 and 13). Method 1800 comprises steps 1802 through 1810. Step 1802 includes providing a first image and a second image, from a training data set, to an input of a machine learning model. Step 1804 includes encoding, with an encoding layer of the machine learning model (e.g., the image-encoder shown in FIG. 1), the first image and the second image into a first encoding and a second encoding, wherein the first encoding and the second encoding are in the spatially consistent latent space. Step 1806 includes computing a loss between the first encoding and the second encoding, wherein the loss is an encoding distance between the first encoding and the second encoding. Step 1808 includes updating the machine learning model based on the computed loss to optimize an encoding distance. Finally, in step 1810, steps 1802 through 1808 are iterated until the machine learning model is appropriately trained (e.g., to achieve training an encoding (e.g., embedding) model S130). When the training procedure is complete, the iterative step 1810 is no longer performed.

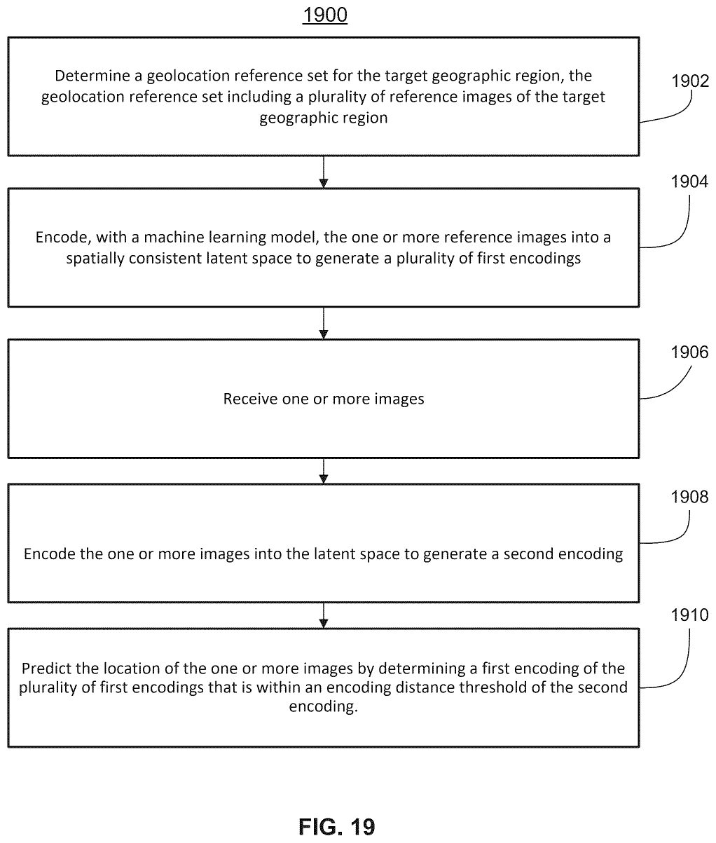

FIG. 19 is a flowchart depicting an exemplary method for locating an image using a machine learning model according to the disclosure (e.g., to achieve geolocating the test measurement S400 shown in FIG. 12). Method 1900 comprises steps 1902 through 1910. Step 1902 includes determining a geolocation reference set for the target geographic region, the geolocation reference set including a plurality of reference images of the target geographic region. Step 1904 includes encoding, with a machine learning model (such as the image-encoder of FIG. 1, or the machine learning model described in relation to FIG. 18), the one or more reference images into a spatially consistent latent space to generate a plurality of first encodings. Step 1906 includes receiving one or more images. Step 1908 includes encoding the one or more images into the latent space to generate a second encoding. Step 1910 includes predicting the location of the one or more images by determining a first encoding of the plurality of first encodings that is within an encoding distance threshold of the second encoding.

Some embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

In some embodiments, there is provided a method of training a machine learning model to encode images into a spatially consistent latent space, such as is illustrated by FIGS. 12, 13, and 18. In some embodiments, the method comprising: (i) providing a first image and a second image, from a training data set, to an input of the machine learning model; (ii) encoding, with an encoding layer of the machine learning model, the first image and the second image into a first encoding and a second encoding, wherein the first encoding and the second encoding are in the spatially consistent latent space; (iii) computing a loss between the first encoding and the second encoding, wherein the loss is an encoding distance between the first encoding and the second encoding; (iv) updating the machine learning model based on the computed loss to optimize an encoding distance; and (v) iterating steps (i) to (iv) with a n-th image and a (n+1)-th image, from the training data set.

In some embodiments, such as is illustrated by FIG. 1, the first image is a first geolocated image including one or more of: first location data, first orientation data, or first time data, the second image is a second geolocated image including one or more of: second location data second orientation data, or second time data, the n-th image is a n-th geolocated image including one or more of: n-th location data, n-th orientation data, or n-th time data, and the (n+1)-th image is a (n+1)-th geolocated image including one or more of: (n+1)-th location data, (n+1)-th orientation data, or (n+1)-th time data.

In some embodiments, the method of training is self-supervised, such as is illustrated by FIG. 13.

In some embodiments, the self-supervised method of training the machine learning model includes a contrastive loss learning function, such as is illustrated by FIG. 10, and wherein the computed loss is a contrastive loss.

In some embodiments, the method further comprises designating the first image and the second image as a positive pair of measurements or negative pair of measurements, wherein images designated as a positive pair of measurements correspond to physical distances closer than a threshold distance, and images designated as a negative pair of measurements correspond to physical distances farther than the threshold distance.

In some embodiments, the method further comprises providing one or more of the first image and/or the second image to the machine learning model with one or more data augmentation processes, including one or more of the following: randomly zooming, randomly flipping, and/or randomly rotating the image.

In some embodiments, the method further comprises determining a co-visibility metric between the first geolocated image and the second geolocated image, and wherein updating the machine learning model is based on the computed loss and based on the co-visibility metric, such as is illustrated by FIGS. 3 and 7.

In some embodiments, the machine learning model comprises a transformer architecture (e.g., a transformer model or transformer-decoder model).

In some embodiments, encoding, with the encoding layer, comprises performing a vector embedding, such as is illustrated by FIG. 1.

In some embodiments, the first encoding is a vector-embedded encoding, and the second encoded is a vector-embedded encoding.

In some embodiments, encoding, with the encoding layer, comprises performing a three-dimensional mesh embedding, the first encoding is a three-dimensional mesh-embedded encoding, and the second encoded is a three-dimensional mesh-embedded encoding.

In some embodiments, the method further comprises determining a physical distance between the first location data and the second location data, wherein updating the machine learning model further includes updating the machine learning model based on the physical distance, such as is illustrated by FIG. 13.

In some embodiments, computing the loss comprises using a sigmoid scaling loss function.

In some embodiments, there is provided a method of training a geolocating machine learning model to predict a geographic location, such as is illustrated by FIGS. 12 and 14, further comprising: training a first machine learning model to encode images into a spatially consistent latent space, providing a first encoding and a second encoding, from an output of the first machine learning model, to an input of the geolocating machine learning model for training a set of geographic prediction layers of the geolocating machine learning model.

In some embodiments, there is provided a method of determining a location of an image within a target geographic region, based on one or more characteristics of the image, such as is illustrated by FIGS. 12 and 14, the method comprising: determining a geolocation reference set for the target geographic region, the geolocation reference set including a plurality of reference images of the target geographic region, encoding, with a machine learning model, the one or more reference images into a spatially consistent latent space to generate a plurality of first encodings, receiving one or more images, encoding the one or more images into the latent space to generate a second encoding, and predicting the location of the one or more images by determining a first encoding of the plurality of first encodings that is within an encoding distance threshold of the second encoding.

In some embodiments, determining the first encoding of the plurality of first encodings that is within the encoding distance threshold of the second encoding is performed by a geolocating machine learning model having a set of geographical prediction layers, such as is illustrated by FIG. 13.

In some embodiments, the method further comprises: after predicting the location of the one or more images, receiving one or more second images, encoding the one or more second images into the latent space to generate a third encoding, and predicting the location of the one or more second images by determining a first encoding of the plurality of first encodings that is within a second encoding distance threshold of the third encoding.

In some embodiments, the method further comprises: predicting an intermediate location between the predicted location of the one or more images and the predicted location of the one or more second images.

In some embodiments, predicting the intermediate location comprises performing an odometry calculation based on data received from one or more sensors, such as is illustrated by FIG. 15.

In some embodiments, performing the odometry calculation comprises one or more of the following: a visual odometry determination, a wheel odometry determination, an inertial odometry determination, RGB-D odometry determination, LIDAR odometry determination, a dead reckoning determination, or a pose determination.

In some embodiments, determining a geolocation reference set includes receiving a second geolocation reference set and constraining the second geolocation reference set based on an odometry calculation.

In some embodiments, the one or more images are received from an image sensor of a vehicle.

In some embodiments, encoding, with a machine learning model, the one or more reference images into a spatially consistent latent space to generate the plurality of first encodings is performed with a first type of encoding, and encoding the one or more images into the latent space to generate the second encoding is performed with the first type of encoding.

In some embodiments, the method further comprises: encoding, with a second type of encoding different from the first type of encoding, the one or more reference images into a spatially consistent latent space to generate a plurality of fourth encodings, encoding, with the second type of encoding, the one or more images into the latent space to generate a fifth encoding, predicting a second location of the one or more images by determining a fourth encoding of the plurality of fourth encodings that is within a third encoding distance threshold of the fifth encoding.

In some embodiments, there is provided a method of generating a training data set for a machine learning model for spatially encoding images into a spatially consistent latent space, the method comprising: receiving a first set of images from a first source, each image of the first set of images including first metadata, receiving a second set of images from a second source, each image of the second set of images including second metadata, and aligning the first set of images and the second set of images based at least partially on the first metadata and the second metadata, such as is illustrated in FIGS. 3, 7, and 8.

In some embodiments, the first metadata includes first location data associated with the first set of images and the second metadata includes second location data associated with the second set of images, such as is illustrated in FIG. 3.

In some embodiments, the first metadata includes first temporal data associated with the first set of images and the second metadata includes second temporal data associated with the second set of images, such as is illustrated in FIG. 3.

In some embodiments, aligning the first set of images and the second set of images includes determining a co-visibility metric between a respective image of the first set of images and a respective image of the second set of images based at least partially on the first metadata and the second metadata.

In some embodiments, the first source and second source each comprise a respective image modality, such as is illustrated in FIG. 2, including: an image sensing device of one or more of the following: a satellite, an aerial drone, a land vehicle, or a memory including one or more synthetically-generated images.

In some embodiments, the image modality of the first source is different from the image modality of the second source.

In some embodiments, the method further comprises: applying one or more data augmentation processes to one or more of the first set of the images or the second set of images, including one or more of the following processes: randomly zooming, randomly flipping, and/or randomly rotating one or more images within the respective set of images.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

1. A method of training a machine learning model to encode images into a spatially consistent latent space, the method comprising:
(i) providing a first image and a second image, from a training data set, to an input of the machine learning model;
(ii) encoding, with an encoding layer of the machine learning model, the first image and the second image into a first encoding and a second encoding, wherein the first encoding and the second encoding are in the spatially consistent latent space;
(iii) computing a loss between the first encoding and the second encoding, wherein the loss is an encoding distance between the first encoding and the second encoding;
(iv) updating the machine learning model based on the computed loss to optimize an encoding distance; and
(v) iterating steps (i) to (iv) with a n-th image and a (n+1)-th image, from the training data set.

2. A method of training a geolocating machine learning model to predict a geographic location, further comprising:
training a first machine learning model to encode images into a spatially consistent latent space according to claim 1,
providing a first encoding and a second encoding, from an output of the first machine learning model, to an input of the geolocating machine learning model for training a set of geographic prediction layers of the geolocating machine learning model.

3. A method of determining a location of an image within a target geographic region, based on one or more characteristics of the image, the method comprising:
determining a geolocation reference set for the target geographic region, the geolocation reference set including a plurality of reference images of the target geographic region,
encoding, with a machine learning model, the one or more reference images into a spatially consistent latent space to generate a plurality of first encodings,
receiving one or more images,
encoding the one or more images into the latent space to generate a second encoding, and
predicting the location of the one or more images by determining a first encoding of the plurality of first encodings that is within an encoding distance threshold of the second encoding.

4. The method of claim 3, wherein determining the first encoding of the plurality of first encodings that is within the encoding distance threshold of the second encoding is performed by a geolocating machine learning model having a set of geographical prediction layers.

5. The method of claim 3, further comprising:
after predicting the location of the one or more images, receiving one or more second images,
encoding the one or more second images into the latent space to generate a third encoding, and
predicting the location of the one or more second images by determining a first encoding of the plurality of first encodings that is within a second encoding distance threshold of the third encoding.

6. The method of claim 5, further comprising:
predicting an intermediate location between the predicted location of the one or more images and the predicted location of the one or more second images.

7. The method of claim 6, wherein predicting the intermediate location comprises performing an odometry calculation based on data received from one or more sensors.

8. The method of claim 7, wherein performing the odometry calculation comprises one or more of the following: a visual odometry determination, a wheel odometry determination, an inertial odometry determination, RGB-D odometry determination, LIDAR odometry determination, a dead reckoning determination, or a pose determination.

9. The method of claim 3, wherein determining a geolocation reference set includes receiving a second geolocation reference set and constraining the second geolocation reference set based on an odometry calculation.

10. The method of claim 3, wherein the one or more images are received from an image sensor of a vehicle.

11. The method of claim 3, wherein
encoding, with a machine learning model, the one or more reference images into a spatially consistent latent space to generate the plurality of first encodings is performed with a first type of encoding, and
encoding the one or more images into the latent space to generate the second encoding is performed with the first type of encoding.

12. The method of claim 11, further comprising:
encoding, with a second type of encoding different from the first type of encoding, the one or more reference images into a spatially consistent latent space to generate a plurality of fourth encodings,
encoding, with the second type of encoding, the one or more images into the latent space to generate a fifth encoding,
predicting a second location of the one or more images by determining a fourth encoding of the plurality of fourth encodings that is within a third encoding distance threshold of the fifth encoding.

13. A method of generating a training data set for a machine learning model for spatially encoding images into a spatially consistent latent space, the method comprising:
receiving a first set of images from a first source, each image of the first set of images including first metadata,
receiving a second set of images from a second source, each image of the second set of images including second metadata, and
aligning the first set of images and the second set of images based at least partially on the first metadata and the second metadata.

14. The method of claim 13, wherein the first metadata includes first location data associated with the first set of images and the second metadata includes second location data associated with the second set of images.

15. The method of claim 14, wherein the first metadata includes first temporal data associated with the first set of images and the second metadata includes second temporal data associated with the second set of images.

16. The method of claim 13, wherein aligning the first set of images and the second set of images includes determining a co-visibility metric between a respective image of the first set of images and a respective image of the second set of images based at least partially on the first metadata and the second metadata.

17. The method of claim 14, wherein aligning the first set of images and the second set of images includes determining a co-visibility metric between a respective image of the first set of images and a respective image of the second set of images based at least partially on the first metadata and the second metadata.

18. The method of claim 14, wherein the first source and second source each comprise a respective image modality, including:
an image sensing device of one or more of the following: a satellite, an aerial drone, a land vehicle, or
a memory including one or more synthetically-generated images.

19. The method of claim 18, wherein the image modality of the first source is different from the image modality of the second source.

20. The method of claim 14, further comprising:
applying one or more data augmentation processes to one or more of the first set of the images or the second set of images, including one or more of the following processes: randomly zooming, randomly flipping, and/or randomly rotating one or more images within the respective set of images.
